(19) United States
(12) Patent Application Publication
(10) Pub. No.: US 2023/0073231 A1
(43) Pub. Date: Mar. 9, 2023

(54) INFORMATION PROCESSING DEVICE, INFORMATION PROCESSING METHOD, AND PROGRAM

(71) Applicant: GRID INC., Tokyo (JP)

(72) Inventors: Masaru Sogabe, Tokyo (JP); Tomah Sogabe, Tokyo (JP); Chih-chieh Chen, Taipei (TW); Kodai Shiba, Tokyo (JP)

(21) Appl. No.: 17/797,069

(22) PCT Filed: Jan. 22, 2021
(86) PCT No.: PCT/JP2021/002132

§ 371 Date: Aug. 2, 2022

Related U.S. Application Data
(60) Provisional application No. 62/980,046, filed on Feb. 21, 2020.

(51) Int. Cl. G06N 10/60; G06N 20/10

(52) U.S. Cl. CPC G06N 10/60; G06N 20/10

(57) ABSTRACT

The purpose of the present invention is to provide an information processing device capable of executing a quantum program, including: a support vector decision unit that decides a support vector from among a plurality of pieces of teacher data; and a classification execution unit that classifies target data into a plurality of classes on the basis of the support vector, wherein the classification execution unit classifies the target data on the basis of results of time evolution computation of an energy level in the case where the target data is treated as an Ising model.

### CROSS-REFERENCES TO RELATED APPLICATIONS

This application is based on U.S. Provisional Patent Application No. 62/980,046, filed on Feb. 21, 2020, which is hereby incorporated herein by reference.

### TECHNICAL FIELD

The present invention relates to an information processing device, an information processing method, and a program.

### BACKGROUND ART

In recent years, machine learning algorithms using quantum computers have been studied extensively. In particular, a quantum support vector machine (QSVM), which is a support vector machine (SVM) using a quantum computer, is one of the algorithms that are expected to improve the performance by using quantum computers.

The support vector machine is a supervised learning algorithm specialized for classification problems, and conventionally several SVM algorithms using quantum computers have been studied (for example, Non-Patent Documents 1 to 4).

### CITATION LIST

### Non-Patent Documents

Non-Patent Document 1: Patrick Rebentrost, Masoud Mohseni and Seth Lloyd, “Quantum support vector machine for big data classification,” arXiv: 1307.0471, 2013.
Non-Patent Document 2: M. Schuld, I. Sinayskiy and F. Petruccione, “An introduction to quantum machine learning,” arXiv: 1409.3097, 2014.
Non-Patent Document 3: Maria Schuld, Mark Fingerhuth and Francesco Petruccione, “Implementing a distance-based classier with a quantum interference circuit,” arXiv: 1703.10793, 2017.
Non-Patent Document 4: Vojtech Havlicek, Antonio D. Corcoles, Kristan Temme, Aram W. Harrow, Abhinav Kandala, Jerry M. Chow and Jay M. Gambetta, “Supervised learning with quantum-enhanced feature spaces,” Nature 567, 209-212, 2019.

### SUMMARY

An object of the present invention is to provide a new quantum support vector machine algorithm using a quantum computer.

### Solution to Problem

According to an aspect of the present invention, there is provided an information processing device capable of executing a quantum program, including: a support vector decision unit that decides a support vector from among a plurality of pieces of teacher data; and a classification execution unit that classifies target data into a plurality of classes on the basis of the support vector, wherein the classification execution unit classifies the target data on the basis of results of time evolution computation of an energy level in the case where the target data is treated as an Ising model.

According to another aspect of the present invention, there is provided an information processing method wherein a computer capable of executing a quantum program performs the steps of: deciding a support vector from among a plurality of pieces of teacher data; and classifying target data into a plurality of classes on the basis of the support vector, wherein the classification step includes classifying the target data on the basis of results of time evolution computation of an energy level in the case where the target data is treated as an Ising model.

According to still another aspect of the present invention, there is provided a program causing a computer capable of executing a quantum program to function as: a support vector decision unit that decides a support vector from among a plurality of pieces of teacher data; and a classification execution unit that classifies target data into a plurality of classes on the basis of the support vector, wherein the classification execution unit classifies the target data on the basis of results of time evolution computation of an energy level in the case where the target data is treated as an Ising model.

### Advantageous Effects of Invention

The present invention enables implementation of a new quantum support vector machine algorithm using a quantum computer.

### BRIEF DESCRIPTION OF DRAWINGS

FIG. 1 is a diagram illustrating a schematic configuration of an information processing device 10 according to one embodiment of the present invention.

FIG. 2 is a block diagram illustrating a module of a quantum program executed by a control unit 12 of the information processing device 10 according to one embodiment of the present invention.

FIG. 3 is a diagram for describing the outline of a support vector machine.

FIG. 4 is a diagram for describing coupling coefficients in an Ising model according to one embodiment of the present invention.

FIG. 5 is a diagram for describing a classification process by an SVM, to which a quantum algorithm is applied, according to one embodiment of the present invention.

FIG. 6 is a diagram illustrating a quantum circuit that performs quantum adiabatic computation according to one embodiment of the present invention.

FIG. 7 is a diagram illustrating a quantum circuit for the Deutsch-Jozsa algorithm according to one embodiment of the present invention.

FIG. 8 is a flowchart of a method of deciding a support vector from teacher data according to one embodiment of the present invention.

FIG. 9 is a diagram for describing a method of deciding a support vector from teacher data according to one embodiment of the present invention.

FIG. 10 is a diagram illustrating a quantum circuit that determines whether or not the classes of respective teacher data are identical, according to one embodiment of the present invention.

FIG. 11 is a diagram illustrating a classification result achieved by the SVM, to which the quantum algorithm is applied, according to one embodiment of the present invention.

FIG. 12 is a diagram illustrating a classification result in the case of using a changed parameter in the SVM, to which the quantum algorithm is applied, according to one embodiment of the present invention.

### DESCRIPTION OF EMBODIMENTS

Hereinafter, embodiments of the present invention will be described in detail with reference to the drawings. The same elements are given the same reference numerals, and duplicate descriptions are omitted.

### Embodiments

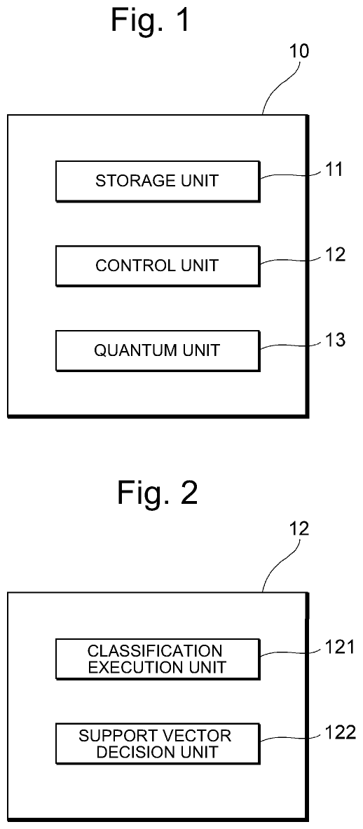

FIG. 1 is a diagram illustrating a schematic configuration of an information processing device 10 according to one embodiment of the present invention. The information processing device 10 is a computer that performs computation by using the quantum mechanical properties of matter, and is able to be a quantum gate type quantum computer. The information processing device 10 is able to be configured with arbitrary hardware.

The information processing device 10 is able to execute the quantum computation algorithm based on a quantum program. The quantum program is a code that represents various quantum algorithms. For example, the quantum program is able to be expressed as a quantum circuit. The quantum program may also contain a program written in a programming language. As illustrated in FIG. 1, the information processing device 10 has a storage unit 11, a control unit 12, and a quantum unit 13.

The storage unit 11 stores various kinds of information. For example, the storage unit 11 stores a quantum program used by the control unit 12 and the quantum unit 13 to execute the quantum computation algorithm.

The control unit 12 controls the quantum unit 13 by means of a processor executing the quantum program to execute the quantum computation algorithm. The control unit 12 may include the functions of a classical computer that executes classical programs to perform various kinds of information processing.

FIG. 2 is a block diagram illustrating a module of a quantum program executed by the processor of the control unit 12. As illustrated in FIG. 2, the functional module of the quantum program includes a classification execution unit 121 and a support vector decision unit 122.

The classification execution unit 121 classifies target data by applying a time evolution computation of an Ising model (Reference Document 2), which is a quantum algorithm, to a support vector machine (hereinafter, referred to as “SVM”: Reference Document 1), which is a machine learning algorithm specialized for classification problems. The classification execution unit 121 classifies the target data into a plurality of clusters on the basis of the support vector that is decided by the support vector decision unit 122. Specifically, the classification execution unit 121 classifies the target data on the basis of the results of time evolution computation of an energy level in the case where the target data is treated as an Ising model.
(Reference Document 1) V. Vapnik and A. Lerner, “Pattern recognition using generalized portrait method,” Automation and Remote Control, 24, 1963.
(Reference Document 2) Tadashi Kadowaki and Hidetoshi Nishimori, “Quantum annealing in the transverse Ising model,” Phys. Rev. E 58, 5355, 1998.

The support vector decision unit 122 decides the support vector that serves as the basis for classifying the target data into a plurality of classes. In this embodiment, the support vector decision unit 122 decides the support vector by applying DBSCAN (Reference Document 3), which is a machine learning clustering algorithm, and the Deutsch-Jozsa algorithm (Reference Document 4), which is a quantum algorithm.
(Reference Document 3) Martin Ester, Hans-Peter Kriegel, Jorg Sander and Xiaowei Xu, “A density-based algorithm for discovering clusters in large spatial databases with noise,” proceeding of 2nd International Conference on Knowledge Discovery and Data Mining, pp. 226-231, 1996.
(Reference Document 4) David Deutsch and Richard Jozsa, “Rapid solution of problems by quantum computation,” Proceedings of the Royal Society of London A, 439, 553, 1992.

(SVM Using Quantum Adiabatic Computation)

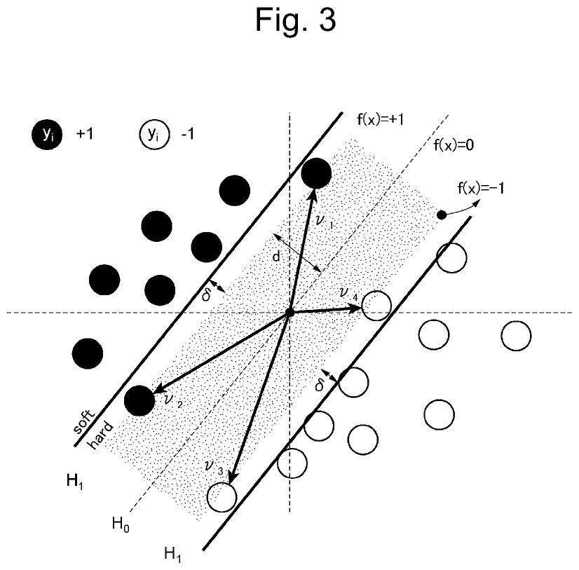

The SVM to which the quantum algorithm is applied according to this embodiment will be described in detail below. First, with reference to FIG. 3, the outline of the SVM in the linear binary classification problem will be described. The classification of target data is performed by maximizing the distance d between the hyperplanes H₁ and H₋₁ illustrated in FIG. 3. The hyperplanes H₁ and H₋₁ are indicated by straight lines with f(x)=wx+B=±1 in the figure. The data points (v1 to v4) on the straight lines with f(x)=±1 are support vectors. Let the point on H₀ be (x₀, y₀). The distance of the straight line Ax+By+ε=0 is able to be expressed as follows, where A=w, B=0, and ε=b:

$$\begin{matrix}[ Math . 1 ] & \\ d - 2 \frac{\vert {Ax}_{0} + {By}_{0} + c \vert}{\sqrt{{A}^{2} + {B}^{2}}} & ( 1 )\end{matrix}$$

In addition, the distance d is able to be expressed more simply by using the condition wx₀+b±1 in H₁ and H₋₁, as illustrated in the following equation:

$$\begin{matrix}[ Math . 2 ] & \\ d - 2 \frac{\vert {Ax}_{0} + {By}_{0} + c \vert}{\sqrt{{A}^{2} + {B}^{2}}} - 2 \frac{\vert {wx}_{0} + b \vert}{\vert w \vert} - \frac{2}{\vert w \vert} & ( 2 )\end{matrix}$$

In the SVM classification problem, the problem of maximizing d is equivalent to the problem of minimizing [w]²/2. Therefore, the Lagrangian of [w]²/2 is able to be expressed as follows, where αi≥0 is a Lagrange's undetermined multiplier:

$$\begin{matrix}[ Math . 3 ] & \\ min L ( w , b , α ) = \frac{1}{2} {\vert w \vert}^{2} - \text{?} & ( 3 )\end{matrix}$$

$$\text{?} \text{indicates text missing or illegible when filed}$$

In addition, considering the following constraints:

$$\begin{matrix}[ Math . 4 ] & \\ \text{?} = 0 & \end{matrix}$$

$$and$$

$$\begin{matrix}[ Math . 5 ] & \\ \text{?} = 0 & \end{matrix}$$

$$\text{?} \text{indicates text missing or illegible when filed}$$

the following equations hold:

$$\begin{matrix}[ Math . 6 ] & \\ \text{?} = 0 & ( 4 )\end{matrix}$$

$$\begin{matrix}[ Math . 7 ] & \\ w = \text{?} & ( 5 )\end{matrix}$$

$$\text{?} \text{indicates text missing or illegible when filed}$$

By assigning equations (4) and (5) to equation (3), the following equation is given, which enables conversion to a dual problem:

$$\begin{matrix}[ Math . 8 ] & \\ max L ( α ) = \text{?} - \frac{1}{2} \text{?} & ( 6 )\end{matrix}$$

$$\text{?} \text{indicates text missing or illegible when filed}$$

Equation (6) satisfies αi≥0 and the equation (4). In the equation (6), xi.xj represents the inner product of two vectors and is able to be regarded as interaction energy. Introducing Kernel matrix Kij=K(x, xj) enables dealing with non-linear problems.

On the other hand, in this embodiment, data are considered as physical particles, and the relationship between data is represented by using the Hamiltonian of the Ising model, which is based on the correlation matrix and the distance matrix. The term expressing the correlation between the data of Hamiltonian and the bias term applied to each piece of data is able to be expressed as follows:

$$\begin{matrix}[ Math . 9 ] & \\ H = \text{?} & ( 7 )\end{matrix}$$

$$\text{?} \text{indicates text missing or illegible when filed}$$

The information processing device 10 is able to simulate Hamiltonian time evolution to decide the energy in the ground state. Equation (7) is considered to be equivalent to the equation (6) by reversing the sign of the equation (7), and the SVM that solves a classification problem is able to be implemented by computing the ground-state energy of the Hamiltonian of the Ising model with the information processing device 10.

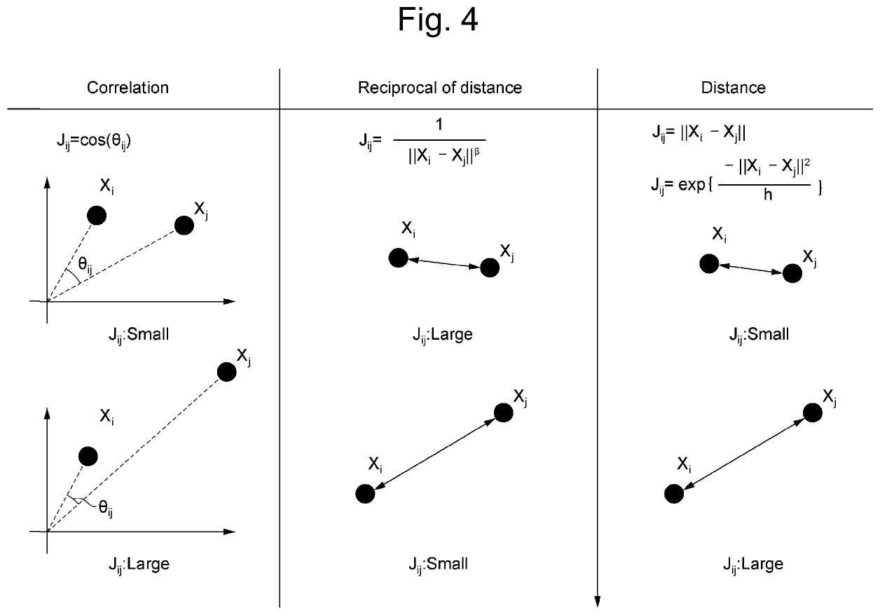

The coupling coefficient Jij in the equation (7) corresponds to the kernel matrix Kij=K(x, xj) in the equation (6), and the correlation (Jij=cos(θij)), the distance (Jij=|Xi-Xj|), the Gaussian kernel (Jij=exp(−σ|Xi-Xj|²)), the reciprocal of distance (1/|Xi-Xj|β), and the like are able to be applied to the coupling coefficient Jij. FIG. 4 is a diagram for describing the coupling coefficients Jij to which the correlation, the reciprocal of distance, and the distance are applied, respectively. The longitudinal field coefficient hzi of the Ising model corresponds to the class label data of the data Xi.

The SVM in this embodiment does not have a learning mechanism and uses the teacher data to predict the class of the test data each time a computation is performed.

First, an Ising model based on a plurality of pieces of teacher data (support vectors) and one piece of test data.

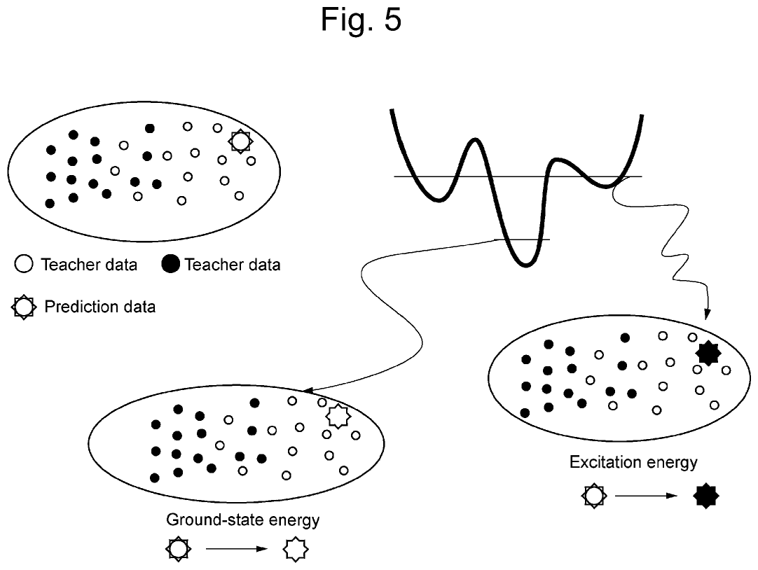

Then, a time evolution computation is performed by using the quantum adiabatic computation (Reference Document 5), and if the class label of the test data is 1 or −1, the value of the Hamiltonian that is determined to be in a stable state is used as a predicted value of the test data. This will be described by giving an example illustrated in FIG. 5. The test data (prediction data) is the ground-state energy when the class label is ∘, and the test data is the excitation energy when the class label is •. Therefore, the class label of the test data is predicted to be ∘, which is the ground-state (stable state).
(Reference Document 5) Edward Farhi, Jeffrey Goldstone, Sam Gutmann and Michael Sipser, “Quantum Computation by Adiabatic Evolution,” quant-ph/0001106, 2000.

The longitudinal field coefficient hzi of the Ising model takes three values, hzi e {−1, 0, 1}. In the case of teacher data, the corresponding class labels hzi e {−1, 1} and hzi=0 are used instead of the test data.

(Quantum Adiabatic Computation)

The quantum unit 13 executes the quantum computation algorithm on the basis of the control by the control unit 12. In this embodiment, the quantum unit 13 executes the quantum adiabatic computation algorithm.

The quantum adiabatic computation algorithm is known as one of the annealing computation methods in which the Ising model is used for computation (Reference Document 5). The Ising model is a model of spin behavior in magnetic materials such as ferromagnets and antiferromagnets. The spin takes two types of states: up-spin (+1) or down-spin (−1).

The Hamiltonian of the entire system of the Ising model is able to be expressed by the following equation (8) by using the coupling coefficient Jij between two spins si and sj and the local longitudinal magnetic field hzi applied to the inside of the spin si:

$$\begin{matrix}[ Math . 10 ] & \\ H = {\sum }_{i < j} \text{?} & ( 8 )\end{matrix}$$

$$\text{?} \text{indicates text missing or illegible when filed}$$

In the quantum adiabatic computation algorithm, a transverse field coefficient hx is added for the setting of the initial state of the Hamiltonian. Furthermore, the spin si corresponds to a Pauli operator σj^{z} and therefore is able to be represented by a phase-reversal operation gate Zi, which is a quantum gate represented by a matrix. Furthermore, a parameter s (=t/tf), in which time t is normalized by tf, is introduced and s is assumed to satisfy 0≤s≤1. Thereby, the Hamiltonian in the quantum adiabatic computation is able to be expressed by the following equation (9):

$$\begin{matrix}[ Math . 11 ] & \\ H ( s ) = s [ {\sum }_{i < j} \text{?} ] + ( 1 - s ) \text{?} & ( 9 )\end{matrix}$$

$$\text{?} \text{indicates text missing or illegible when filed}$$

A quantum computer is able to perform unitary transformations in sequence to represent the time evolution of the Schrödinger equation. Assuming that the state vector of a qubit is |ψ>, the Schrödinger equation is able to be expressed by the following equation (10):

$$\begin{matrix}[ Math . 12 ] & \\ ih \frac{\partial }{\partial t} \vert ψ 〉 = H \vert ψ 〉 & ( 10 )\end{matrix}$$

Solving the Schrödinger equation when the state vector is time-dependent and the Hamiltonian is time-independent, the Schrödinger equation is able to be transformed as in equations (11) and (12), and the unitary transformation U(t) is derived.

$$\begin{matrix}[ Math . 13 ] & \\ \vert ψ ( t ) 〉 = \text{?} \vert ψ ( t ) 〉 & ( 11 )\end{matrix}$$

$$\begin{matrix}[ Math . 14 ] & \\ U ( t ) = \text{?} & ( 12 )\end{matrix}$$

$$\text{?} \text{indicates text missing or illegible when filed}$$

By substituting the equation (9) for H in the equation (12) and repeating the unitary transformation U (t), the minimum value of the Hamiltonian is obtained and thus the optimum spin state is acquired.

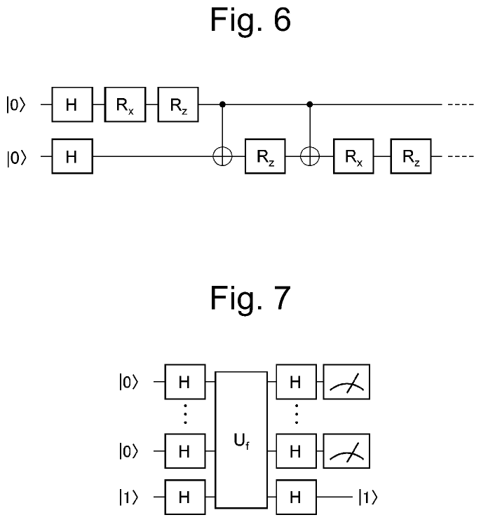

U(t) in the equation (12) is called the time evolution operator, and the detailed quantum circuit is able to be illustrated as in FIG. 6. In H of the equation (9), the term of the coupling coefficient corresponds to the combination of two gates, the CNOT gate and the Rz gate of the quantum circuit, the term of the longitudinal magnetic field corresponds to the Rz gate, and the term of the transverse magnetic field corresponds to the Rx gate.

Each coefficient, the time evolution coefficient s, or the like is input as an input angle of the rotary gate. Thus, for example, if s evolves over 100 steps, the part other than the two H gates illustrated in FIG. 6 is repeated 100 times.

(Decision of Support Vectors)

Subsequently, the deciding process of a support vector by the support vector decision unit 122 is described in detail below. In this embodiment, DBSCAN (Reference Document 3) and the Deutsch-Jozsa algorithm (Reference Document 4) are applied to decide the support vector.

Density-based spatial clustering of applications with noise (DBSCAN) is a machine learning clustering algorithm. Data points are classified into three types according to the number of other data points within a circle of radius c centered at each data point, and clusters are generated on the basis of the classification.

FIG. 7 is a diagram illustrating a quantum circuit of the Deutsch-Jozsa algorithm. The Deutsch-Jozsa algorithm is a quantum algorithm that decides in one measurement whether the output f(x){0, 1} of the binary function f(x) for n-qubit binary input x ∈ {0, 1}n depends on the input x (balanced) or not (constant).

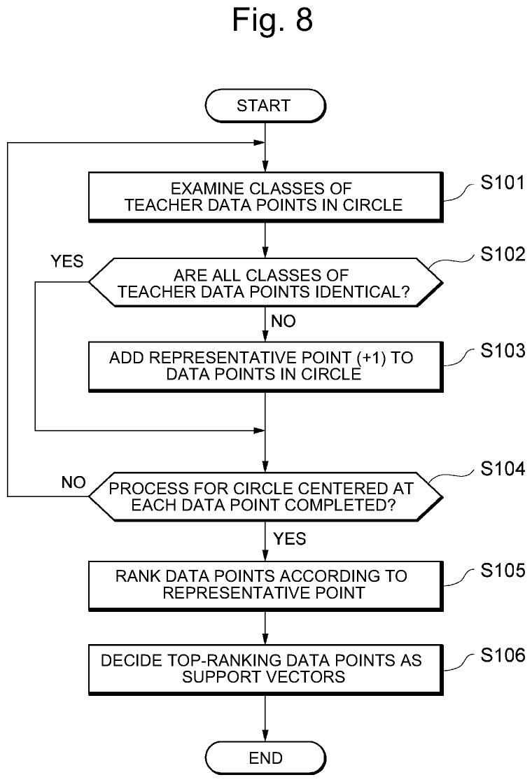

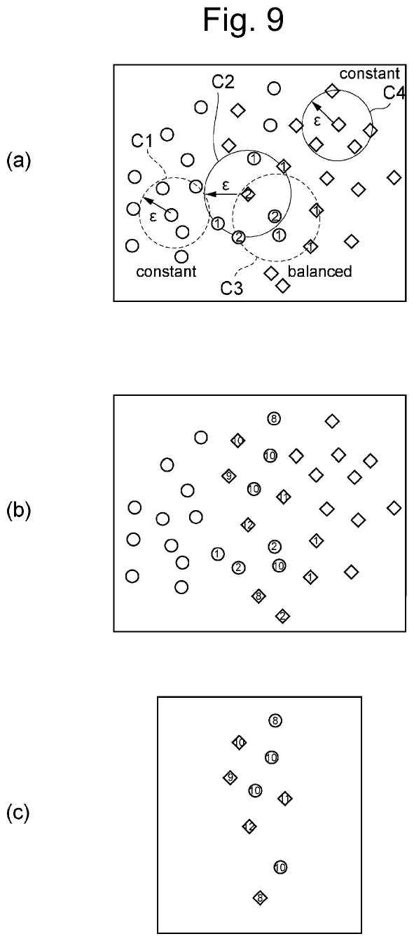

Subsequently, with reference to the flowchart in FIG. 8 and FIG. 9, description is made on a method of deciding a support vector from among a plurality of pieces of teacher data by applying the concepts of the DBSCAN and the Deutsch-Jozsa algorithm.

First, examination is performed on the class labels of other teacher data points located within a circle of radius c centered at each teacher data point (step S101). FIG. 9(a) is a diagram illustrating a plurality of teacher data points and circles C1 to C4 of radius c centered at one of the teacher data points. In the figure, marks ∘ and [symbol] represent data points with the same class label.

Then, it is determined whether all of the teacher data in the circle including the central data point belong to the same class (constant) or teacher data of different classes are mixed (balanced) (step S102). For example, in the example illustrated in FIG. 9(a), the circles C1 and C4 are determined to be constant (step S102: YES) since the classes of data points in each circle are all marked ∘ or [symbol] . On the other hand, the circles C2 and C3 are determined to be balanced (step S102: NO) since both marks ∘ and [symbol] are mixed in each circle.

If there are a plurality of classes in a circle (step S102: NO), a representative point+1 is added to all data points located within the circle (step S103). For example, in the example illustrated in FIG. 9(a), +1 is added to each data point contained in the circle C2 or C3, respectively. In FIG. 9(a), the number in a mark ∘ or [symbol] indicates the representative point given to each data point. The data point marked “1” is a point included in either one of the circles C2 and C3 (including the one on the boundary line), and the data point marked “2” is a point included in both circles C2 and C3. The points that are located within the balanced circle are recognized as the data points of the representative points RP near the boundaries of a plurality of clusters.

After repeating steps S101 to S103 for the circles centered at all teacher data points (step S104), respective data points are ranked according to the size of the representative point added to each data point (step S105). The ranking of data points is described by using FIG. 9(b). FIG. 9(b) illustrates the representative points given to respective data points after steps S101 to S103 are performed for the circle centered at each teacher data point. For example, the data point marked “10” indicates that the data point is included in 10 circles that are determined to be balanced. Respective teacher data points are ranked in descending order of representative points.

Subsequently, the data of the top 1/a of the ranking are decided as support vectors for all teacher data (step S106). FIG. 9(c) illustrates the top ¼ (nine) of the ranking among the teacher data points (36) illustrated in FIG. 9(b). For example, top-ranking teacher data are able to be decided to be support vectors in this manner.

The distance between respective teacher data points is able to be regarded as the coupling coefficient Jij in the Ising model. In this specification, the coupling coefficient Jij is assumed to be a reciprocal of distance between respective teacher data points. In this case, the presence or absence of other teacher data points within the circle of radius c is decided by the following equation:

Jij=1/|Xi-Xj|β<ε (13)

The symbol ε is a hyperparameter, by which the number of teacher data points contained within the circle is able to be adjusted.

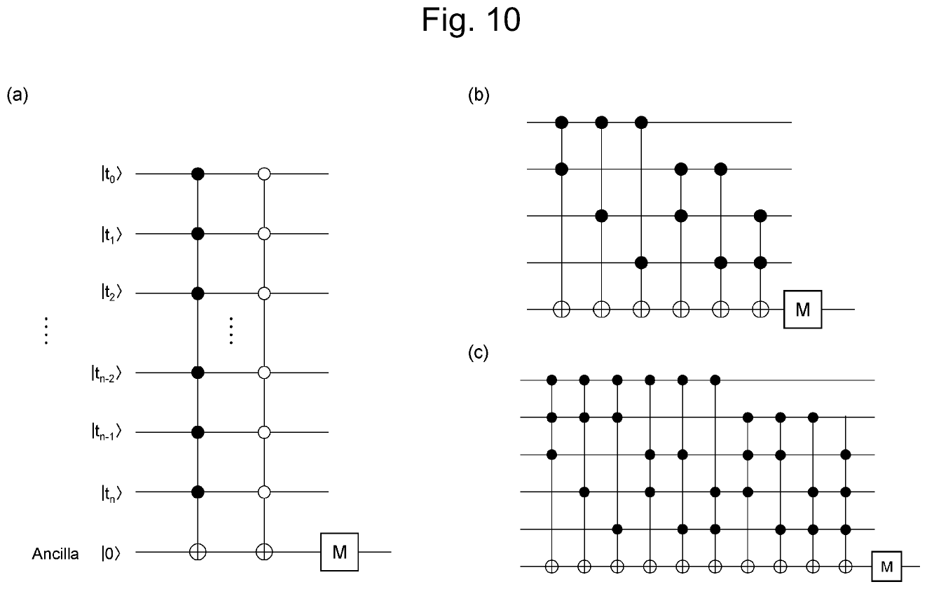

FIG. 10(a) is a diagram illustrating a quantum circuit that determines whether the classes of the teacher data contained within the circle are identical or not (constant or balanced) in step S102. The quantum circuit in FIG. 10(a) has a qubit corresponding to the number of the teacher data points contained in the circle and one auxiliary bit, and the label value of each teacher data class f(x) ∈{0,1} is set as the input of the quantum circuit |t₀> to |tₙ>, |0>.

According to the quantum circuit in FIG. 10(a), the auxiliary bit is inverted only in the case where all classes of the teacher data in the circle are 0 or 1. Therefore, if the observed auxiliary bit is 0, the teacher data in the circle is a mixture of a plurality of classes (balanced), and the teacher data points in the circle are determined to be the representative points RP. In addition, since the quantum circuit illustrated in FIG. 10 is a quantum circuit that uses the multi-control NOT gate twice, the number of qubits to be used increases according to the number of pieces of teacher data, which makes the implementation of the multi-control NOT gate difficult. Therefore, it is desirable to find the optimal value of the number of data points contained in the circle by adjusting the number with the radius ε as a hyperparameter.

After the number of points certified as representative points RP by the quantum circuit is totaled as described above, the top 1/a data are decided to be support vectors. The symbol α is a hyperparameter, and the number of support vectors varies greatly depending on the distribution of teacher data. Therefore, it is necessary to adjust a according to the distribution of teacher data.

FIGS. 10(b) and 10(c) are diagrams illustrating other examples of the quantum circuit that determines whether or not the classes of teacher data contained within a circle are identical or not. The quantum circuit in FIG. 10(b) determines the state to be balanced in the case where teacher data points of two types of classes are contained in the same proportion in a circle. FIG. 10(c) illustrates a circuit that determines the state to be balanced in the case where teacher data points of the respective classes are contained in a given ratio (in this case, 2:3) in a circle. FIGS. 10(a) to 10(c) illustrate the oracle patterns of the Deutsch-Jozsa algorithm, respectively. The quantum circuit illustrated in FIG. 10(a) is characterized by having loose classification constraints similarly to the soft margin of the SVM, while the quantum circuit illustrated in FIG. 10(b) is characterized by having tight classification constraints similarly to the hard margin of the SVM. The quantum circuit illustrated in FIG. 10(c) has classification constraints corresponding to those between the soft and hard margins.

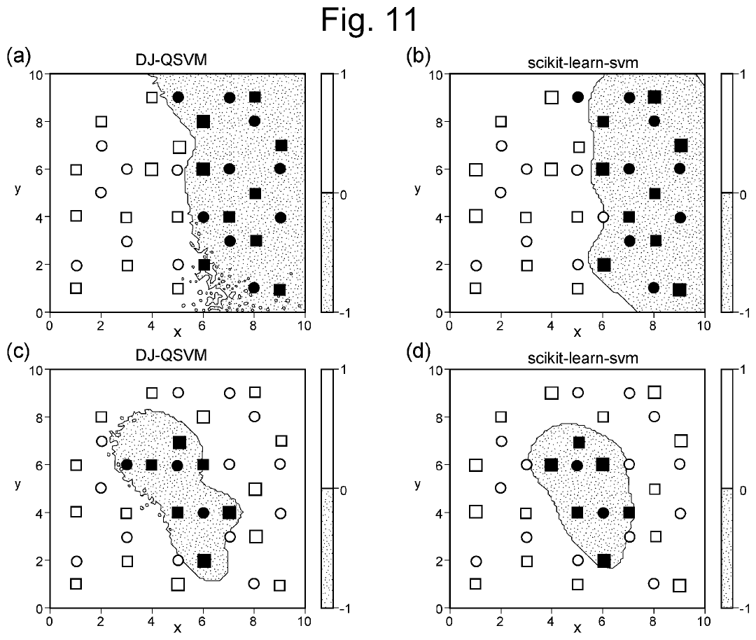

Subsequently, the classification process of the information processing device 10 according to this embodiment is described by giving an example of classifying test data of two types of teacher data (linear data and nonlinear data). In addition, the classification results are compared with the classification results obtained by using the scikit-learn SVM, which is a known method. FIG. 11(a) illustrates the results of linear data classification by the quantum SVM with the Deutsch-Jozsa algorithm applied (hereafter, referred to as “DJ-QSVM”) according to this embodiment, and FIG. 11(b) illustrates the results of linear data classification by the scikit-learn SVM. FIG. 11(c) illustrates the results of nonlinear data classification according to this embodiment, and FIG. 11(d) illustrates the results of nonlinear data classification by the scikit-learn SVM. In FIGS. 11(a) to (d), square dots (□ and ▪) represent teacher data. In the case of linear data (FIGS. 11(a) and 11(b)), there are 11 teacher data (□) with +1 label and nine teacher data (▪) with −1 label. In the case of nonlinear data, there are 14 teacher data (□) with +1 label and six teacher data (▪) with −1 label. Among the teacher data, those indicated by large squares are support vectors. A circle dot (∘) indicates test data, and the number of test data is 17 for both linear and nonlinear data.

In the classification by the DJ-QSVM according to this embodiment, the radius of a scan circle was set to ε=0.5 for linear data and ε=0.6 for nonlinear data, and the power of the reciprocal of distance between data was set to β=1. In addition, α=3 was set to decide ⅓ of the ranking data to be support vectors. For comparison, the same classification was further performed by using the scikit-learn SVM.

As illustrated in FIG. 11, it is found that the DJ-QSVM according to this embodiment enables both linear and nonlinear data to be classified in the same manner as the scikit-learn SVM. If, however, only the arrangement of teacher data is changed without changing the number of the teacher data, the classification was sometimes unsuccessful. This may be due to the small number of teacher data. In other words, if the number of teacher data is too small, the number of support vectors may be insufficient and the accuracy of classification may decrease. Therefore, it is desirable to perform the classification by using a large number of teacher data.

In the DJ-QSVM according to this embodiment, however, the classification is performed by using several qubits, which are combinations of all support vectors and one piece of test data. Therefore, if the number of teacher data is too large, the accuracy of the computation is reduced, and in the case of the simulator, the computation time may increase problematically. Therefore, it is desirable to enable large teacher data to be computed without increasing the number of qubits.

Table 1 illustrates the maximum time complexity in a Kernel SVM (the scikit-learn SVM) and the DJ-QSVM. In Table 1, d denotes the dimension of the feature space, n denotes the number of training data, and k denotes the number of support vectors. Ta is the time required to find the ground state in the Ising model. As illustrated in Table 1, in the process of deciding support vectors (training), this embodiment (DJ-QSVM) enables a reduction in the time complexity.

TABLE 1

| | Training | Prediction |
|---|---|---|
| Kernel SVM | O(n³d) | O(kd) |
| DJ-QSVM | O(n²d) | O(k²d) + Tₐ |

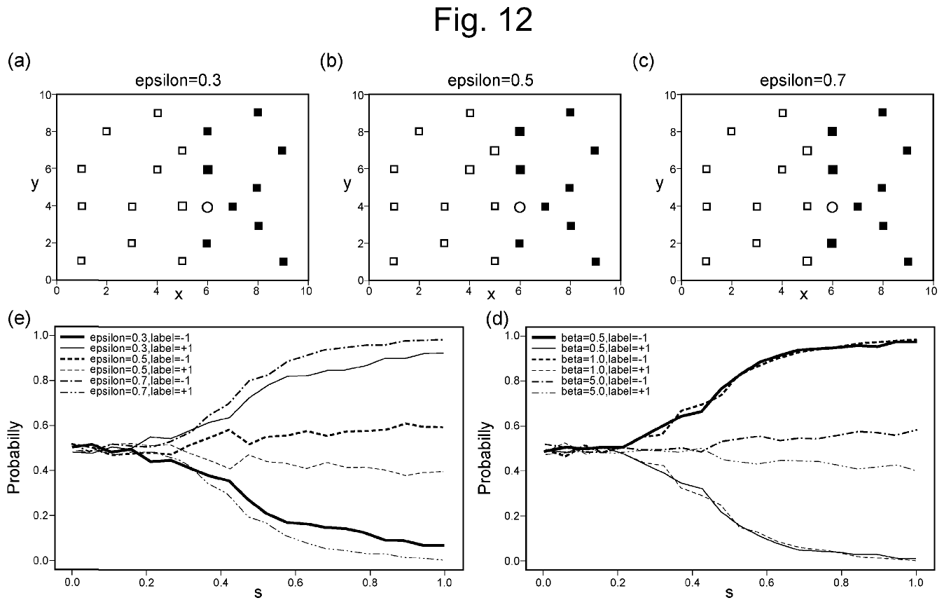

Subsequently, FIG. 12 illustrates the results of verifying the influence on class label prediction caused by changing the parameters ε and β in the classification of linear data by the DJ-QSVM according to this embodiment.

FIGS. 12(a), 12(b), and 12(c) illustrate the support vectors in the case where c is set to 0.3, 0.5, and 0.7, respectively. In FIGS. 12(a) to 12(c), the mark ∘ represents the test data (x, y)=(6, 4) for predicting the class. FIG. 12(d) illustrates the time evolution of the quantum adiabatic computation for various values of ε. In FIG. 12(d), ε is varied to three types, 0.3, 0.5, and 0.7. The higher probability of the +1 label or the −1 label is the predicted label. As for other hyperparameters, β=1 and α=3.

As illustrated in FIG. 12(d), it is understood that different prediction results of the classes are obtained as c changes. Furthermore, in the case of ε=0.3 for the teacher data with the +1 label with respect to the test data, the prediction result is +1. In the case where the teacher data with the −1 label is close to ε=0.7, the prediction result is −1. In addition, it is understood that the probabilities of +1 and −1 obtained as the prediction results are as indicated by ε=0.5, in other words, the probabilities of +1 and −1 are approximately equal to each other in the case where the test data are at the same distance from the teacher data of two classes.

FIG. 12(e) illustrates the change in prediction results in the case where β is varied to three types, 0.5, 1.0, and 5.0. Note that α=3, ε, and test data are set as in FIG. 12(c). As illustrated in FIG. 12(e), it is understood that the larger the value of β, the smaller the difference from other data, and the probabilities of +1 and −1 as the prediction results are almost equal to each other.

As described above, it is found that the prediction results also change when ε and β are changed. These hyperparameters change depending on the coordinates of the test data, the number and types of teacher data, and the like. Therefore, it is important to set the hyperparameters appropriately in order to increase the accuracy of classification.

As described above, according to this embodiment, the time evolution simulation algorithm of the Ising model is applied to a support vector machine that classifies test data by using teacher data, and the quantum unit 13 performs quantum adiabatic computation, so that data is able to be classified in a method using the quantum adiabatic computation.

To decide a support vector, it is determined whether all the teacher data contained within a circle of radius c centered at each piece of teacher data have the same class or different classes, the relevant teacher data are ranked on the basis of the number of times a certain piece of teacher data is contained in a circle containing teacher data having different classes, and then a support vector is decided from among the plurality of pieces of teacher data on the basis of the rank. In addition, the concept of the Deutsch-Jozsa algorithm is applied to determining whether the classes of teacher data in a circle are identical or different. This significantly reduces the time complexity required for deciding the support vector.

The present invention is not limited to the embodiments described above, but may be implemented in various other forms within the scope not departing from the gist of the present invention. For this reason, the above embodiments are merely illustrative in all respects and are not to be construed as limiting. For example, the respective processing steps described above may be arbitrarily reordered or executed in parallel, to the extent that they do not cause any inconsistency in the processing contents.

Reference Signs List

10 information processing device
11 storage unit
12 control unit
13 quantum unit
121 classification execution unit
122 support vector decision unit

1. An information processing device capable of executing a quantum program, comprising:
a support vector decision unit that decides a support vector from among a plurality of pieces of teacher data; and
a classification execution unit that classifies target data into a plurality of classes on the basis of the support vector,
wherein the classification execution unit classifies the target data on the basis of results of time evolution computation of an energy level in the case where the target data is treated as an Ising model.

2. The information processing device according to claim 1, wherein the support vector decision unit ranks the teacher data on the basis of the number of teacher data of different classes surrounding a certain piece of teacher data and decides the support vector from among the plurality of pieces of teacher data on the basis of the rank.

3. The information processing device according to claim 2, wherein the support vector decision unit determines whether all classes of teacher data contained within a circle of radius c centered at each piece of teacher data are identical or different, and ranks the teacher data on the basis of the number of times a certain piece of teacher data is contained in the circle with the different classes.

4. The information processing device according to claim 2, wherein the support vector decision unit analyzes the number of pieces of teacher data of different classes surrounding a certain piece of teacher data by using the Deutsch-Jozsa quantum computation algorithm.

5. An information processing method,
wherein a computer capable of executing a quantum program performs the steps of:
deciding a support vector from among a plurality of pieces of teacher data; and
classifying target data into a plurality of classes on the basis of the support vector, and
wherein the classification step includes classifying the target data on the basis of results of time evolution computation of an energy level in the case where the target data is treated as an Ising model.

6. A program causing a computer capable of executing a quantum program to function as:
a support vector decision unit that decides a support vector from among a plurality of pieces of teacher data; and
a classification execution unit that classifies target data into a plurality of classes on the basis of the support vector,
wherein the classification execution unit classifies the target data on the basis of results of time evolution computation of an energy level in the case where the target data is treated as an Ising model.
